(19) United States
(12) Patent Application Publication
(10) Pub. No.: US 2017/0186020 A1
(43) Pub. Date: Jun. 29, 2017

(54) ECO-COST DOCUMENT PROCESSING JOB QUOTA MANAGEMENT

(71) Applicants: Kabushiki Kaisha Toshiba, Minato-ku (JP); Toshiba TEC Kabushiki Kaisha, Shinagawa-ku (JP)

(72) Inventors: Marianne L. Kodmer, Huntington Beach, CA (US); Michael L. Yeung, Vission Viejo, CA (US)

(21) Appl. No.: 14/981,276

(22) Filed: Dec. 28, 2015

(51) Int. Cl. G06Q 30/00; H04N 1/32; H04N 1/00

(52) U.S. Cl. CPC G06Q 30/018; H04N 1/00204; H04N 1/00323; H04N 1/00832; H04N 1/00875; H04N 1/32101; H04N 2201/0094; H04N 2201/3202

(57) ABSTRACT

A system and method for monitoring document processing device operations, gauging corresponding cost, including monetary or environmental cost, and facilitating review of actual and projected costs associated with usage levels. The system receives usage data corresponding to metered use of an associated networked document processing device by each of a plurality of users. Memory associated with the processor stores received usage data and stores relationship data corresponding to a relationship between usage data and data corresponding to an associated environmental impact. The processor applies relationship data to usage data to compute environmental impact data representative of an environmental impact corresponding to the usage data. The display then generates an image corresponding to the environmental impact data. An administrator is enabled to view historic or projected costs and manage quotas accordingly.

### TECHNICAL FIELD

This application relates generally to addressing environmental impact relative to resources used by office devices. The application has particular application in monitoring of consumable resources in networked document processing devices, along with related control of device operation parameters.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). MFPs are used in connection with example embodiments disclosed in detail below, but it is to be appreciated that any suitable document processing device can be used. Given the expense of purchasing and maintaining MFPs, including the costs of consumables, devices are frequently shared among users in a networking environment. Common networks include local-area networks (LANs) and wide-area networks (LANs). Wide-area networks may span multiple regions, such as with the Internet.

Offices may choose to allocate expenses associated with document processing device operations in accordance with use. Such allocation helps eliminate unnecessary costs, or pushes costs to those who use the devices most.

### SUMMARY

In accordance with an example embodiment of the subject application, a processing system includes an input to receive usage data corresponding to metered use of an associated networked document processing device by each of a plurality of users. Memory associated with the processor stores received usage data and stores relationship data corresponding to a relationship between usage data and data corresponding to an associated environmental impact. The processor applies relationship data to usage data to compute environmental impact data representative of an environmental impact corresponding to the usage data. The display then generates an image corresponding to the environmental impact data.

In accordance with another example embodiment, quota data is stored in the memory for each of the plurality of users, wherein the quota data corresponds to document processing device user limits. The processor compares usage data to quota data for each of the plurality of users and selectively suspends document processing device operations for users in accordance with a comparison of the usage data and the quota data.

In accordance with another example embodiment, the processor calculates a projected environmental impact corresponding to projected use of the networked document processing device, and a corresponding display is generated.

### BRIEF DESCRIPTION OF THE DRAWINGS

Various embodiments will become better understood with regard to the following description, appended claims and accompanying drawings wherein:

FIG. 1 illustrates an example embodiment of an overview of a document processing quota management system;

FIG. 2 illustrates an example embodiment of a hardware platform for a document processing device;

FIG. 3 illustrates an example embodiment of a hardware platform for document processing quota management;

FIG. 4 illustrates an example embodiment of a user interface for input of quota data;

FIG. 5 illustrates an example embodiment of an output illustrating job counter output over time;

FIG. 6 illustrates an example embodiment of an output showing impact relating to quota adjustment;

FIG. 7 illustrates a second example embodiment of an output showing impact relating to quota adjustment; and

FIG. 8 illustrates a flowchart of an example embodiment of quota management.

### DETAILED DESCRIPTION

Cost control has been a goal relative to use of document processing devices. More recently, there is an increasing awareness of resource limitations and the impact of mankind and his activities on the environment. Accordingly, understanding of resource usage and its associated environmental impact is beneficial in connection with a document processing environment.

In a basic system, control of resource usage is suitably accomplished by imposing usage quotas. A user, or group of users, may be, for example, limited to a certain number of pages per month of printing or copying. Quotas are set over any suitable duration, such as quarters, semesters, years, etc. Document processing operations not only take a toll on the useful life of a device, but they require power consumption, processor utilization, consumption of paper or other tangible rendering medium, and consumption of ink, toner or the like.

Quotas may be set on number of copies or printouts, as noted above. Quotas may also be set on any suitable, measurable quantity, such as ink usage, toner usage, numbers of color pages, numbers of black-and-white pages, and the like. In a typical quota-based environment, a user or group of users may be precluded from certain device activities until a current period has passed once the allotted level has been attained.

Numeric quota levels do not necessarily reflect a dynamic effect on cost, savings or environmental impact. In example embodiments detailed herein, information is isolated for resource usage for document processing devices relative to measures of environmental impact. Such data is suitably empirical, or suitably calculated from any statistical formula or suitable mathematical model. There are readily available sources of data for the impact of MFP consumables on the environment. By way of example, The Environmental Paper Network has published a “Paper Calculator” at http://c.environmentalpaper.org which correlates paper consumption to environmental impact.

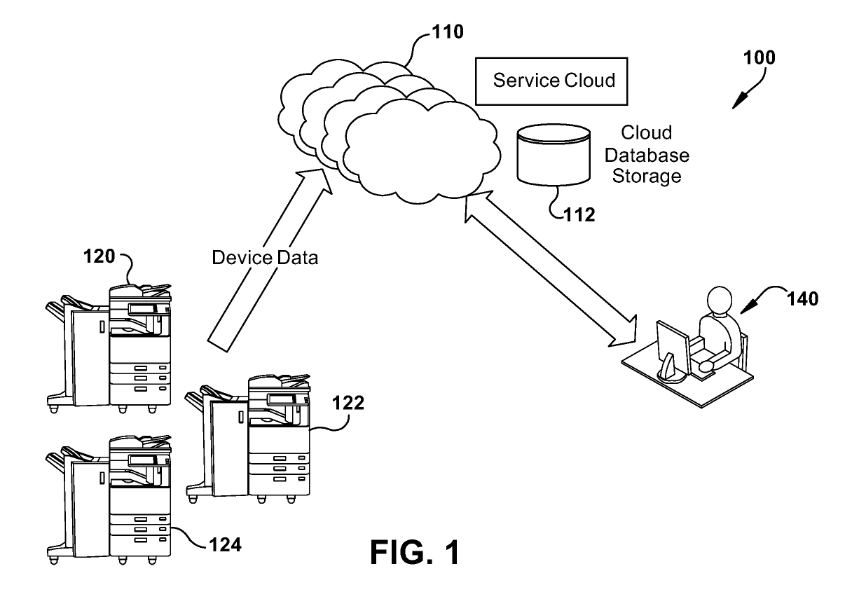

Turning to FIG. 1, illustrated is an example embodiment of a document processing quota management system 100. A data network, illustrated by data service cloud 110, is comprised of any suitable network, such as those noted above. A data storage system 112 is suitably associated with the data service cloud 110, and suitably stores data associated with consumable usage, user quotas, environmental impact relationship data, and any other data storage needs. One or more document processing devices, such as MFPs 120, 122 and 124 are also in data communication with data service cloud 110. Document processing devices are suitably distributed on one or more premises in one or more geographic areas. Also in data communication with data service cloud 110 are one or more administrators 140 interacting with any suitable data processing device. As will be detailed below, the administrators 140 are provided with information relative to quota values, usage values and environmental impact values, including historic, current and projected.

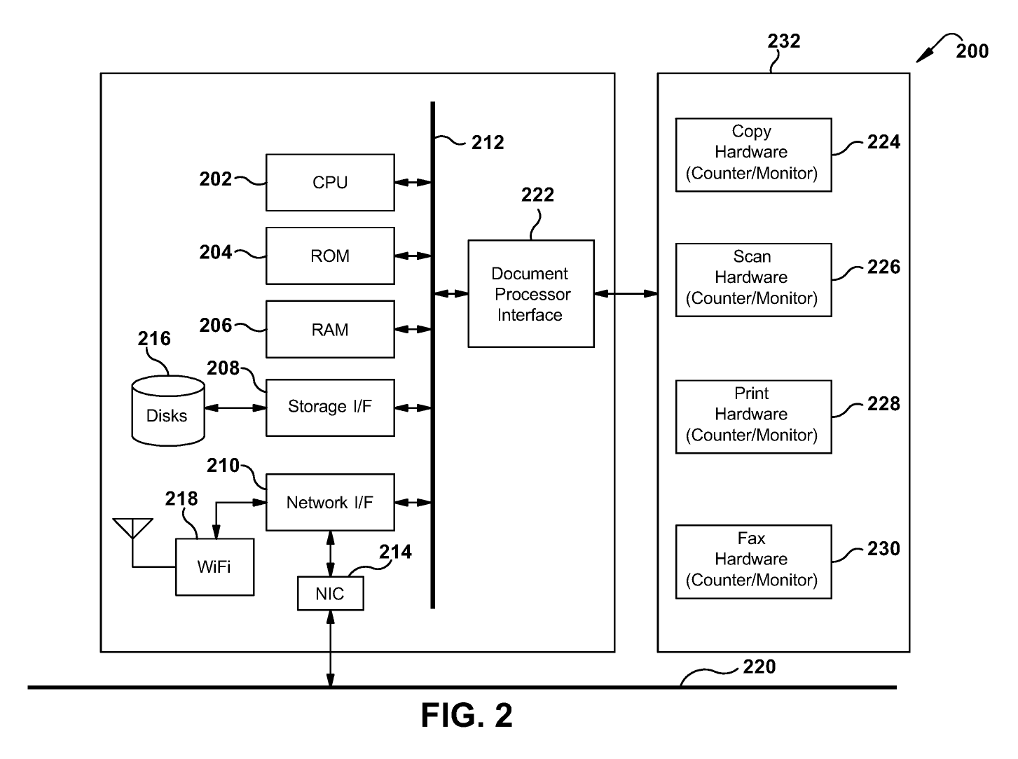

Turning now to FIG. 2, illustrated is an example of a digital processing system 200 suitably comprised within an MFP, such as MFP 120. Included are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), telephone line, or the like. NIC 214 and wireless network interface 218 suitably provide for connection to an associated network 220.

Processor 202 can also be in data communication with any suitable user input/output (I/O) interface which provides data communication with user peripherals, such as displays, keyboards, mice, track balls, touch screens, or the like. Also in data communication with data bus 212 is a document processor interface suitable for data communication with MFP functional units. In the illustrate example, these units include copy hardware 224, scan hardware 226, print hardware 228 and fax hardware 230 which together comprise MFP functional hardware 232. It will be understood that functional units are suitably comprised of intelligent units, including any suitable hardware or software platform.

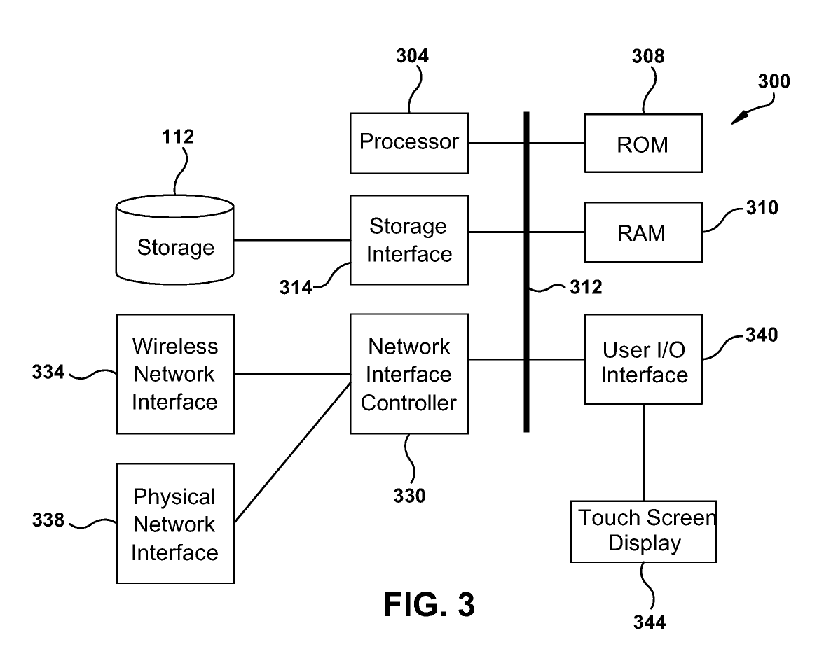

Turning now to FIG. 3, illustrated is an example of a digital processing system 300 suitably comprised within data service cloud 110 of FIG. 1. Included are one or more processors, such as that illustrated by processor 304. Each processor is suitably associated with non-volatile memory, such as ROM 308, and random access memory (RAM) 310, via a data bus 312.

Processor 304 is also in data communication with a storage interface 314 for reading or writing to a data storage system 112, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 238, or to any suitable wireless data connection via wireless network interface 334. Example wireless connections include cellular, Wi-Fi, Bluetooth, NFC, wireless universal serial bus (wireless USB), satellite, and the like. Example wired interfaces include Ethernet, USB, IEEE 1394 (FireWire), telephone line, or the like.

Processor 304 is also in data communication with a user input/output (I/O) interface 340 which provides data communication with user peripherals, such as display 344, as well as keyboards, mice, track balls, touch screens, or the like. It will be understood that functional units are suitably comprised of intelligent units, including any suitable hardware or software platform.

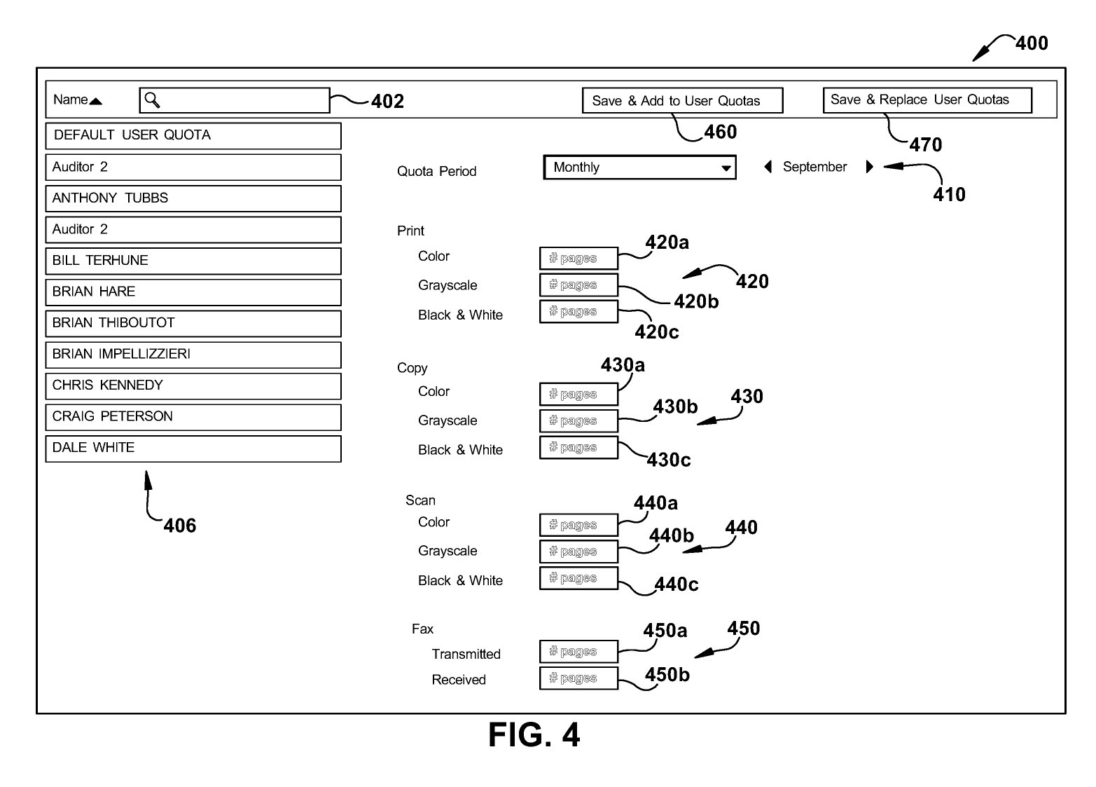

Turning now to FIG. 4, illustrated is an example embodiment of a user interface 400 for quota management. This details example interaction between an administrator and any suitable document processing quota enforcement system. Name field 402 is suitably provided for entry of an identifier, such as administrator name, user group name, network name, device name, or the like. In the example embodiment, user group 406 includes a listing of identifiers of users affected by quota management. Quota period field 410 suitably allows the administrator to set a time period during which a particular quota number will be monitored and enforced, and after which another quota period may recommence.

As detailed above, an MFP may include functionality for printing, copying, scanning or faxing. In the example embodiment of FIG. 4, suitable print quotas 420 may include color print quotas 420a, grayscale print quotas 420b and black-and-white print quotas 420c. It will be appreciated that such types of printing may result in different costs, such as environmental impact costs, such as use of more ink or toner, different ink or toner colors, or special paper stocks to accommodate them. Analogous costing may be associated with copy quotas 430, suitably including color copy quotas 430a, grayscale copy quotas 430b and black-and-white copy quotas 430c.

Quotas are also suitably set for use of scanning resources. Scanning quotas 440 suitable include color scanning quotas 440a, grayscale scanning quotas 440b and black-and-white scanning quotas 440c. Faxing quotas 450 suitably include sending or transmitting quotas 450a and receiving quotas 450b. By way of further example, received faxes may consume more resources given the use of paper and additional electricity, as well as wear and tear on the device itself.

Any or all of the quota values are suitably selected or input by an administrator in the corresponding fields. In the example embodiment, input quota information is suitably saved and added by selection of button 460, or save and replaced by selection of button 470, after which selection they quotas are implemented relative to monitoring and enforcement.

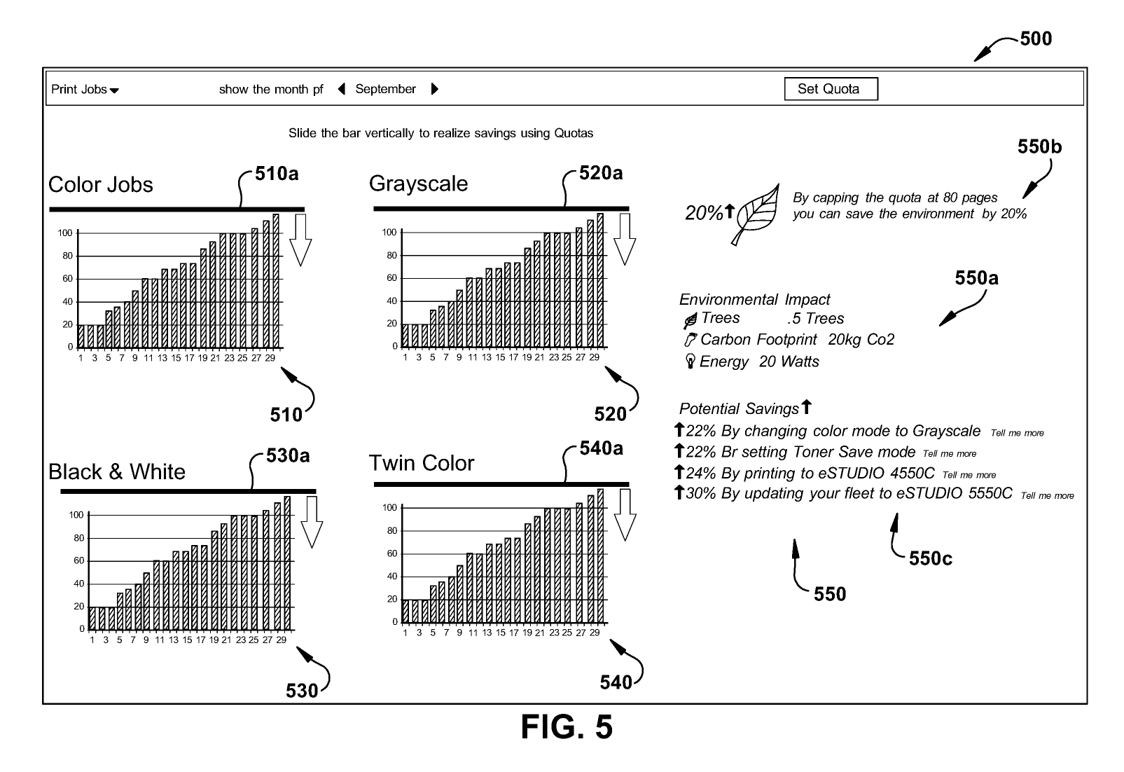

Turning now to FIG. 5, illustrated is an example embodiment of an output of document processing job activity summary 500. The example display output includes graphs of historic job information, including color jobs 510, grayscale jobs 520, black-and-white jobs 530 and twin color jobs 540. Environmental impact associated with the resource consumption with the usage levels is suitably determined and displayed at resource summary area 550. In the example, the total environmental impact for actual devise usage is suitably determined and displayed at 550a, and informational or suggestive information relative to resource allocation and impact is suitably displayed at 550b and 550c. The display suitably comprises data indicative of cost of actual or projected consumable usage.

In a further example embodiment illustrated by FIG. 5, graphs 510, 520, 530 and 540 each include a user-controllable tool for projecting environmental impact of various quota settings, suitably viewed by dragging projected quota setting bars 510a, 520a, 530a and 540a to a position indicative of higher or lower quotas. A user suitably selects a bar 510a, 520a, 530a or 540a with a pointing device and drags it upward or downward to indicate greater or lesser quotas. Contemporaneously with such dragging, environmental impact values are dynamically changed to show how such quota modification increases or decreases environmental impact. An administrator may note that grayscale rendering often provides an acceptable substitute to twin color rendering, but with significantly less environmental impact per unit. This can be particularly useful when administrators are tasked with maintaining overall environmental impact goals, such as dictated by management, governmental regulation or a desire to maintain a low environmental impact to obtain or sustain environmental certification levels. For example, a company may stand to benefit substantially with Leadership in Energy and Environmental Design (LEED) certification. Such certification can provide substantial branding and marketing value, and can lead to potential tax savings or other financial incentives.

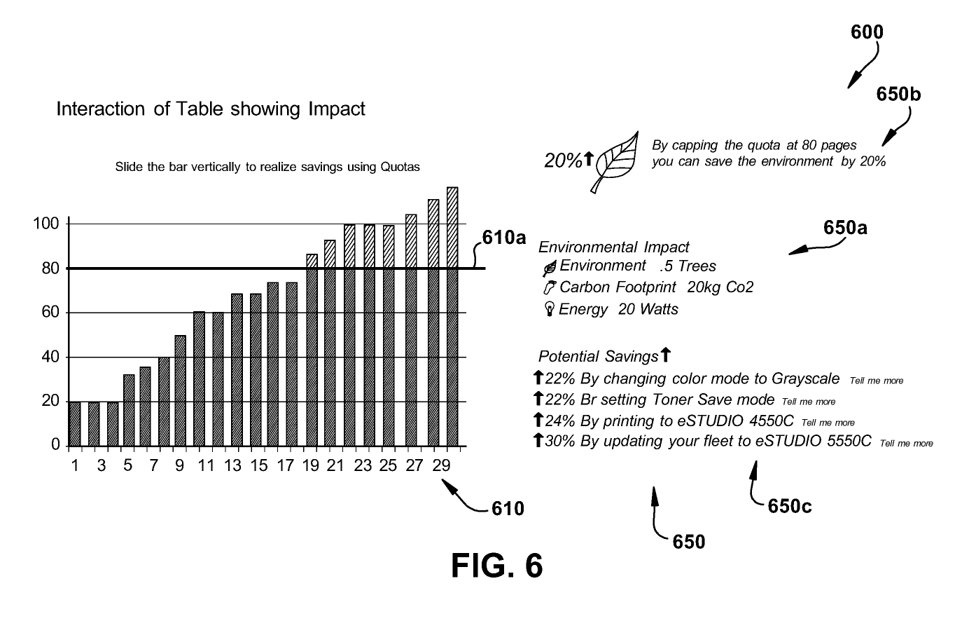

FIG. 6 illustrates an example embodiment of quota interaction 600 of an administrator with actual and potential quota values to dynamically gage environmental impact, including historic and prospective. A table 610 includes historic usage data superimposed with a slider bar 610a, analogous to those detailed above. In the illustrated example, the bar 610a is set at a quota level of 80 units. Environmental impact display area 650 suitably includes impact for actual device usage is suitably determined and displayed at 650a, and informational or suggestive information relative to resource allocation and impact is suitably displayed at 650b and 650c. In the illustration, the levels relating to the quota set at 80 are displayed at 650a. Dragging the bar 610a upward or downward results in prospective impact being displayed at 650a relative to an effect of higher quotas or lower quotas, respectively.

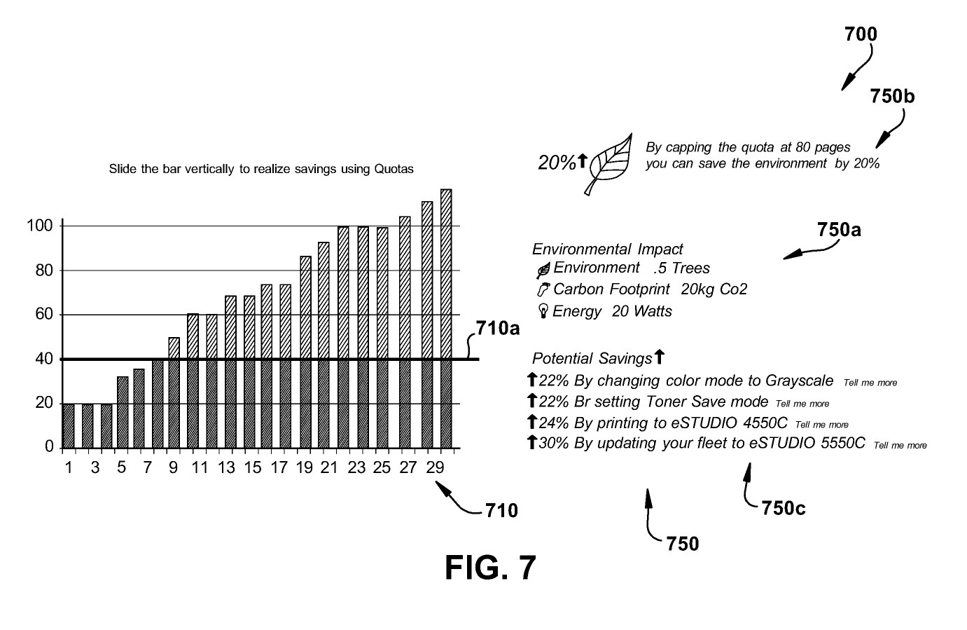

Referring now to FIG. 7, illustrated is an example embodiment of quota interaction 700 of an administrator with actual and potential quota values to dynamically gage environmental impact, including historic and prospective. A table 710 includes historic usage data superimposed with a slider bar 710a, analogous to those detailed above. In the illustrated example, the bar 710a is set at a quota level of 40 units. Environmental impact display area 750 suitably includes impact for actual device usage is suitably determined and displayed at 750a, and informational or suggestive information relative to resource allocation and impact is suitably displayed at 750b and 750c. In the illustration, the levels relating to the quota set at 40 are displayed at 750a. Dragging the bar 710a upward or downward results in prospective impact being displayed at 750a relative to an effect of higher quotas or lower quotas, respectively.

Viewing FIG. 6 and FIG. 7 contemporaneously demonstrates an example embodiment of dynamic interaction with an administrator. Thus, an administrator is enabled to view, assess and control resource utilization by manipulation of document processing quotas.

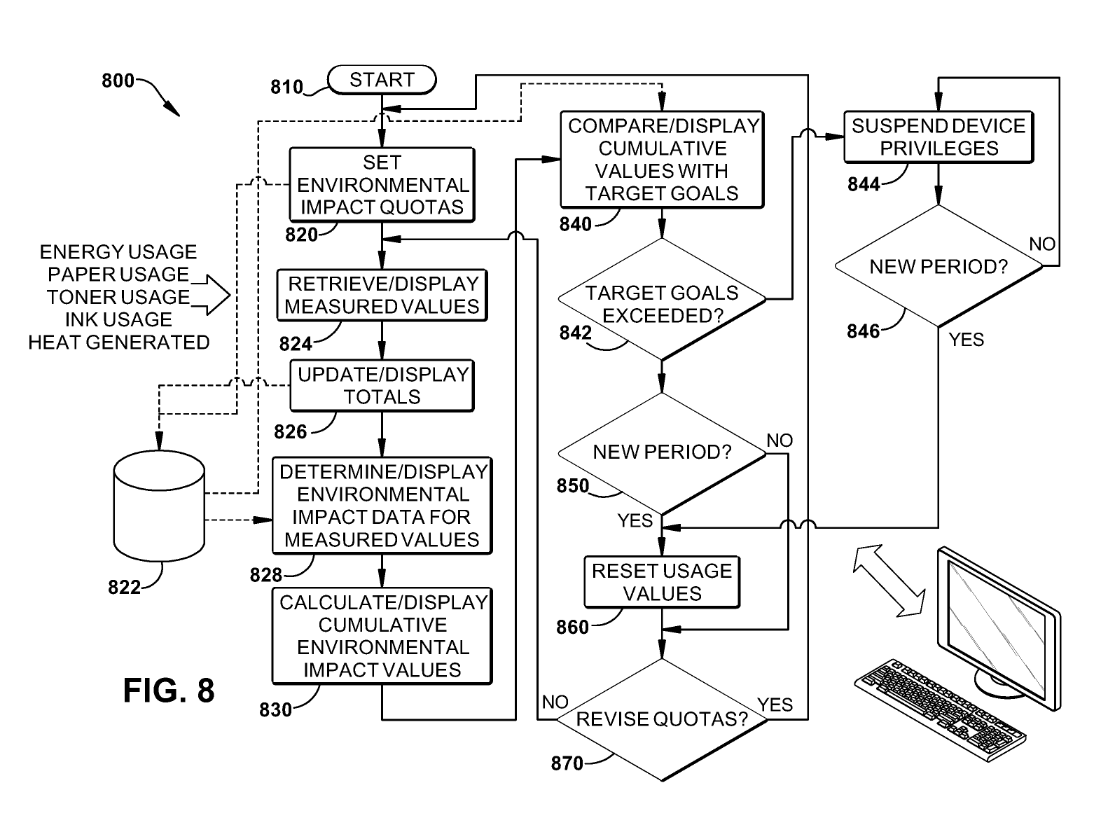

Turning now to FIG. 8, illustrated is an example embodiment of a flowchart for quota administration 800. The process suitably commences at block 810, and proceeds to block 820 to secure an understanding of environmental impact quotas. Such quotas may include job quotas, or may alternatively be directed to resultant environmental impact. Data associated with quota administration 800 may be stored in and retrieved from any suitable memory storage, such as cloud storage 822. Next, at block 824, actual use data is obtained from one or more document processing devices, and this information is archived in cloud storage 822 at block 826. A determination of associated environmental impact is suitably made and displayed at block 828. Cumulative environmental impact values are suitably determined and displayed at block 830.

Next, at cumulative environmental values are compared with target values at 840, and a determination is made as to whether target goals were exceeded at 842. If so, suspension of device privileges for one or more users may be implemented at block 844, with such suspension being maintained until it is determined at block 846 that a new quota period has commenced. If target quotas are determined not to be exceeded at block 842, a determination is made at block 850 as to whether a new period is commenced. If so, usage values are reset at block 860, which is also achieved when a determination is made that a new period has commenced at block 846. Next a determination is made at block 870 as to whether quotas are to be revised. If so, progress is suitably returned to block 820 to set quotas. If not, progress is suitably returned to block 824 and updated use data is retrieved and displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
an input operable to receive usage data corresponding to metered use of an associated networked document processing device by each of a plurality of users;
a memory operable to store received usage data and further operable to store relationship data corresponding to a relationship between usage data and data corresponding to an associated environmental impact;
a processor operable to apply relationship data to usage data to compute environmental impact data representative of an environmental impact corresponding to the usage data; and
a display operable to generate an image corresponding to the environmental impact data.

2. The device of claim 1 wherein the memory is further operable to store quota data for each of the plurality of users, the quota data corresponding to document processing device user limits,
wherein the processor is further operable to compare usage data to quota data for each of the plurality of users and
wherein the processor is further operable to selectively suspend document processing device operations for users in accordance with a comparison of the usage data and the quota data.

3. The device of claim 2 wherein the processor is further operable to calculate a projected environmental impact corresponding to projected use of the networked document processing device, and
wherein the display is further operable to generate an image corresponding to the projected environmental impact.

4. The device of claim 3 wherein the processor is further operable to apply received target environmental impact data to the environmental impact data, and
wherein the processor is further operable to modify the quota data in accordance with the target data and the environmental impact data and the projected environmental impact data.

5. The device of claim 3 further comprising:
an input operable to receive target environmental impact data, and
wherein the processor is further operable to apply received target environmental impact data to projected environmental impact data, and
wherein the processor is further operable to modify the quota data in accordance with the target environmental impact data and the projected environmental impact data.

6. The device of claim 5 wherein the usage data is comprised of data indicative of document processing device consumables.

7. The device of claim 6 wherein the document processing device consumables include one or more of toner, ink, print medium or energy.

8. A method comprising:
receiving usage data corresponding to metered use of an associated networked document processing device by each of a plurality of users;
storing received usage data in an associated memory;
storing, in the memory, relationship data corresponding to a relationship between usage data and data corresponding to an associated environmental impact;
calculating an environmental impact of operation of the document processing device by processing, in an associated processor, relationship data and usage data to obtain environmental impact data representative of a probable environmental impact associated with the usage data; and
generating an image corresponding to the environmental impact data.

9. The method of claim 8 further comprising:
storing, in the memory, quota data for each of the plurality of users, the quota data corresponding to document processing device user limits;
comparing, via the processor, usage data to quota data for each of the plurality of users; and
selectively suspending document processing device operations for users in accordance with a result of the comparing.

10. The method of claim 9 further comprising:
calculating, via the processor, a projected environmental impact corresponding to projected use of the networked document processing device, and
wherein the generated image corresponds to the projected environmental impact.

11. The method of claim 10 further comprising:
applying, via the processor, received target environmental impact data to the environmental impact data; and
modifying, via the processor, the quota data in accordance with the target data and the environmental impact data and the projected environmental impact data.

12. The method of claim 10 further comprising:
receiving target environmental impact data;
applying, via the processor, received target environmental impact data to projected environmental impact data; and
modifying, via the processor, the quota data in accordance with the target environmental impact data and the projected environmental impact data.

13. The method of claim 12 wherein the usage data is comprised of data indicative of document processing device consumables.

14. The method of claim 13 wherein the document processing device consumables include one or more of toner, ink, print medium or energy.

15. A system comprising:
a processor and associated memory;
a network interface operable to receive usage data corresponding to metered usage of consumables by each of a plurality of document processing devices by each of a plurality of users;
a display operable to generate an image corresponding to environmental impact data; and
an input operable to receive projected usage data, and
wherein the memory is operable for storing relationship data corresponding to a relationship between consumable usage and data corresponding to an associated environmental impact,
wherein the memory is operable to store quota data corresponding to a quota of document processing operations for each of the plurality of users,
wherein the processor is further operable to calculate historic environmental impact data for each user in accordance with associated usage data and the relationship data,
wherein the processor is further operable to generate projected impact data for each user in accordance with the historic environmental impact data, the relationship data and the projected usage data, and
wherein the display is further operable to generate an image corresponding to the projected impact data.

16. The system of claim 15 wherein the processor is further operable to set updated quota data in accordance with the projected impact data.

17. The system of claim 15 wherein the memory is further operable to store cost data corresponding to a cost associated with the usage of consumables, and wherein the display is further operable to generate an image corresponding to the cost data.

18. The system of claim 17 wherein the processor is further operable to generate projected cost data in accordance with the cost data and the projected impact data, and wherein the display is further operable to generate an image corresponding to the projected cost data.

19. The system of claim 15 wherein the usage data includes data corresponding to use of consumables including one or more of paper, energy, ink or toner by the document processing devices.

20. The system of claim 15 wherein the relationship data includes data associated with one or more of carbon footprint, energy or tree cost.
